(19) United States
(12) Patent Application Publication
(10) Pub. No.: US 2024/0003078 A1
(43) Pub. Date: Jan. 4, 2024

(54) COFFEE RECYCLED VEGAN LEATHER SHEET AND MANUFACTURING METHOD THEREFOR

(71) Applicant: ENR CO., LTD., Busan (KR)

(72) Inventors: Ho Jin KIM, Busan (KR); Won Ju KIM, Busan (KR); Jung Kwang YOON, Busan (KR); Jin Soo KANG, Busan (KR)

(21) Appl. No.: 17/979,945

(22) Filed: Nov. 3, 2022

(30) Foreign Application Priority Data
Jul. 1, 2022 (KR) 10-2022-0081319
Sep. 27, 2022 (KR) 10-2022-0122655

(51) Int. Cl. D06N 3/00; B32B 5/02; B32B 9/04; B32B 9/02

(52) U.S. Cl. CPC D06N 3/0061; B32B 5/02; B32B 9/047; B32B 9/02; B32B 2255/02; B32B 2255/26; B32B 2255/28; B32B 2250/02; D06N 2205/106

(57) ABSTRACT

A coffee recycled vegan leather sheet and the method for manufacturing the coffee recycled vegan leather sheet may include: a coffee grounds powder manufacturing step of drying coffee grounds to remove moisture, and pulverizing a dried coffee grounds to produce micronized coffee grounds powder; a first mixing step of mixing the coffee grounds powder obtained from the coffee grounds powder manufacturing step and a shaving scrap and latex, which are usually used as raw materials for recycled leather, into a mixing tank, respectively, and a second mixing step of adding a fatliquoring agent and a dispersing agent for imparting flexibility to the mixture into the mixing tank for mixing; a coffee regenerated leather molding step of drying the mixture that has undergone the secondary mixing step and passing it between pressing rolls to compression-mold it into regenerated coffee leather.

### CROSS-REFERENCE TO RELATED APPLICATION

This application claims under 35 U.S.C. § 119(a) the benefit of priority to Korean Patent Application No. 10-2022-0122655 filed on Sep. 27, 2022 and Korean Patent Application No. 10-2022-0081319 filed on Jul. 1, 2022, the entire contents of which are incorporated herein by reference.

### TECHNOLOGY FIELD

The present invention relates to a coffee recycled vegan leather sheet and a method for manufacturing the same, and more particularly, coffee grounds powder is mixed with a shaving scrap used as a recycled leather raw material, and then the recycled leather sheet is manufactured through a wet process. By doing so, it relates to a coffee recycled vegan leather sheet and a method for manufacturing the same, which can realize antibacterial and deodorizing effects due to the unique characteristics.

### BACKGROUND OF THE INVENTION

As is well known, waste generated when processing leather or various fibers such as artificial leather or natural leather and scrap remaining after using them are utilized in various fields, but the scope of their application is very limited. In addition, since most leather waste or scrap is disposed of by landfill or incineration, it is a serious environmental problem.

As described above, the biggest reason that wastes and scraps such as natural leather, artificial leather, and textiles cause environmental problems is the inability to recycle wastes and scraps through methods such as incineration and landfill due to a decrease in the recycling rate.

On the other hand, various research for recycling leather wastes that are recently incinerated or landfilled are in progress.

In particular, research on the development of interior materials for construction, leather sheets, and the like, is being conducted as a way to industrially utilize fibers of leather waste.

In the case of vegan leather, which is partly used in the synthetic leather manufacturing industry, riding on the recent global trend, a small amount of powder or liquid extracted from nature is added to the general coating materials on woven or non- woven fabric to produce vegan leather or bio leather is suggested to the buyer, but it is true that there is no case of quality verification and it is somewhat difficult to analyze and check the scientific basis or the content of the extract itself.

In addition, although vegan leather or bio-leather is distributed in the market, the price is also extremely expensive compared to conventional synthetic leather or recycled leather, so it is expected to be somewhat difficult to commercialize in reality.

On the other hand, as is generally known, the size of world coffee consumption is mainly in three countries Europe such as the United States, and Brazil are at the top. In recent years, the consumption of coffee distributed in Korea has been on the rise.

In a case of Korea, it accounts for around 1.8% of global consumption, and a size of the domestic sales market is estimated to be about 3 trillion won, and the amount is imported at a scale of about 150,000 tons or more.

Most are classified into Green Bean, Roast & Ground Coffee, and Instant Coffee granules.

Coffee raw materials are processed into instant mixed coffee containing sugar or cream (oil component) and 7 to 13% caffeine to suit the taste of consumers.

In the case of maniacs who do not meet the tastes of domestic consumers, the generation of coffee beans that can be roasted and ground directly and extracted with hot water simply using a coffee maker to feel the true aroma is gradually increasing.

On the other hand, as the consumption of coffee beans has greatly increased, the amount of coffee grounds remaining after extracting the raw coffee solution from the ground coffee is also increasing.

A growing number of generations enjoy coffee beans, which can be roasted, and ground directly, and simply extracted with hot water using a coffee maker to feel the true aroma.

Coffee grounds are inevitably generated waste due to the consumption of coffee beans, and on average, if 0.2% of coffee is brewed from coffee beans, the remaining 99.8% will remain in a form of coffee grounds.

consumption of coffee beans continues to increase every year; the amount of coffee grounds is also expected to increase geometrically.

A large amount of carbon dioxide is generated during landfilling and processing of coffee grounds, and when used as compost without a decaffeination process, salt accumulation may occur, which may cause ecosystem disturbance.

In recent years, the issue of recycling coffee grounds as a new resource, which is constantly increasing, has also become a matter of great interest.

### REFERENCES

### Patents

Patent Document 1: Unexamined Korean Publication No. 10-2018-0030738, titled ‘Cocopeat or coffee grounds which is eco and up cycling applied to handbag (Large leather goods) and wallet (small leather goods) body material or inside reinforcement material’ published on Mar. 26, 2018.

Patent Document 2: Korean Patent Registration No. KR10-2001771, titled ‘Manufacturing method for eco-friendly working materials with coffee waste,’ issued on Jul. 18, 2019.

Patent Document 3: Unexamined Korean Publication No. 10-2021-0092006, titled ‘Waterproof Paper Straw using Coffee Ground and Manufacturing Method thereof,’ published on Jul. 23, 2022.

Patent Document 4: Unexamined Korean Publication No. 10-2021-0092927, titled ‘MANUFACTURING METHOD FOR INTERIOR TILES USING COFFEE GROUNDS,’ published on Jul. 27, 2021.

### DESCRIPTIONS OF THE INVENTION

### Problems to be Solved

An aspect of the present invention is to provide a method for preparing a recycled leather sheet by mixing coffee grounds and a coffee recycled vegan leather sheet prepared by the method.

Aspect(s) of the present invention provides a method of mixing coffee grounds powder in a shaving scrap used as a recycled leather raw material, and then making it a recycled leather sheet through a wet process and a coffee recycled vegan leather sheet prepared by the above method.

Another object of the present invention is to provide coffee recycled vegan leather and a method of manufacturing thereof that can implement antimicrobial and deodorizing effects.

Another object of the present invention is to provide a coffee recycled vegan leather sheet capable of implementing functions such as filling and flexibility, and a method for manufacturing the same.

### Means for solving Problems

In the method for manufacturing a coffee recycled vegan leather sheet according to the present invention may include: coffee grounds powder manufacturing step 100 of a drying 10 to 500 kg of coffee grounds to remove moisture, putting dried coffee grounds into a grinder to prepare coffee grounds powder, putting the coffee grounds powder into a vacuum container and rapidly frozen in a freezer, applying vacuum to the vacuum container to remove moisture remaining in the coffee grounds powder after drying the coffee grounds, taking out the coffee grounds powder from the vacuum container, putting the coffee grounds powder into a grinder to produce undifferentiated coffee grounds powder having a particle size of 1,000 μm or less; a first mixing step of 300-800 kg of shaving scrap made by pulverizing 10-100 mm long and short fibers, which are generally raw materials for coffee recycled leather, 20-25 ton weight of water, and a latex selected from SBR synthetic latex or NR natural latex are added to the mixing tank, and then 10-500 kg of coffee powder produced in the above coffee powder manufacturing step 100 is mixed together; a second mixing step 300 of re-mixing the fatliquoring agent 100-300 kg weight and the additive 10-200 kg weight into the mixing tank; a step 400 of compression molding the recycled coffee leather by forcibly sucking the mixture that has undergone the secondary mixing step 300 with a suction machine, spraying it through a filtering net, and then passing it between pressing rolls after a drying process 400;

Step 400 of compression molding the coffee recycled leather by forcibly sucking the mixture that has undergone the secondary mixing step 300 with a suction machine, spraying it through a filtering net, and then passing it between pressing rolls after a drying process 400.

The method for manufacturing a coffee recycled vegan leather sheet according to the present invention may include the coffee grounds powder manufacturing step 100, the first mixing step 200, the second mixing step 300, a coffee recycled leather forming step 400, after sandpapering the front or back side of the coffee recycled leather made through the coffee recycled leather forming step 400, a fiber bonding step 500 of bonding any one of general yarn fibers such as PU-based, PE-based, and Cationic Dyeable Polyester (CDP)-based fibers, natural yarn, and recycled yarn fibers, a needle punching step 600 of reinforcing physical strength by needle-punching the coffee recycled leather sheet to which the fibers are bonded with a needle punching machine.

In addition, aspects of the present invention may further include a coating step 700 of applying a PU coating solution to the surface of the coffee recycled leather that has undergone the fiber bonding step 500 and the needle punching step 600.

### Effects of the Invention

The present invention can prevent environmental pollution by recycling leather sheets using leather, such as natural leather or artificial leather, or various leather wastes and scraps.

In addition, there are advantages to produce a soft and light coffee recycled vegan leather sheet with a coffee scent, as well as a deodorizing function and antibacterial effect, by mixing the coffee grounds thrown away in a coffee chain store into micronized treatment when manufacturing the recycled leather sheet.

In addition, the present invention generally provides a coffee recycled vegan leather sheet by mixing a pulverized coffee grounds powder with a size of 1,000 microns or less with a shaving scrap, which is generally pulverized leather waste, and a leather fiber to produce a coffee recycled vegan leather sheet. Not only is it high in strength, but it also has a deodorizing function and antibacterial effect due to the characteristics of the coffee recycled leather sheet, and it has a coffee scent and is light and soft in weight, so it can be applied to various products such as bags, shoes, sofas, furniture, and interior materials of automobiles.

### BRIEF DESCRIPTIONS OF THE DRAWINGS

FIG. 1 is a diagram illustrating a method of manufacturing a coffee recycled vegan leather sheet according to an embodiment of the present invention.

FIG. 2 is a diagram showing a configuration of a coffee recycled vegan leather sheet manufactured by the method shown in FIG. 1.

### DETAILED DESCRIPTION OF THE INVENTION

Hereinafter, preferred embodiments of the present invention will be described in detail with reference to the accompanying drawings. In the detailed description to be described later, representative embodiments of the present invention will be presented in order to achieve the above-described technical problems. And other embodiments that can be presented as the present invention is replaced by the description in the configuration of the present invention.

The term ‘coffee grounds’ used in the present invention has the same meaning as ‘coffee grounds’ as a by-product left after making coffee and refers to the residues left after extracting the coffee undiluted solution from ground coffee. In addition, the coffee grounds may include the epidermis and by-products of green coffee beans peeled off from the green coffee beans and may include coffee powder.

In addition, the term a ‘coffee recycled leather’ as used in the present invention refers to recycled leather containing coffee grounds in a broad sense, and in a narrow sense refers to a recycled leather made after the coffee grounds powder preparation step 100, a primary mixing step 200, a second mixing step 300, and a coffee recycled leather forming step 400.

And the term ‘coffee recycled leather sheet’ as used in the present invention refers to a form of a sheet formed by another layer on the surface of the coffee recycled leather, and in the description of the present invention, the coffee recycled leather sheet refers to the result made through the fiber bonding step 500 and the needle punching step 600, or the coffee recycled leather sheet corresponding to the result made through the coating step 700.

An object of an aspect of the present invention is to prepare a coffee recycled vegan leather sheet by mixing the remaining coffee grounds distributed in the market with the shaving scrap used as a recycled leather raw material.

To this purpose, an aspect of the present invention may include collecting coffee grounds, first simple hot air drying, and then pulverizing treatment to pulverize the coarse coffee grounds into a coarse coffee grounds powder or granular form.

Secondary powdered coffee grounds powder is placed in a container, the temperature is rapidly lowered, and then a vacuum is applied to the inside of the container in a frozen state to sublimate the moisture inside the coffee grounds to steam and dry it by freeze-drying or Lyophilization.

It is finely pulverized and then pulverized to a light size and finely pulverized (powder) through the process of first pulverizing it to less than 1,000 microns.

The reason the coffee grounds are freeze-dried as above is to minimize the inherent coffee aroma components such as caffeine contained in the coffee grounds.

Compared to hot air drying, the increase in crystallinity is small, and there is a very advantageous advantage in maintaining a fine structure such as processing or fibrous form.

A method of manufacturing a coffee recycled vegan leather sheet using such coffee grounds may include: putting pre-pulverized shaving scraps into a mixing tank with a scale of 25 tons or more and mixing with 20-25 tons of water, and mixing with SBR-based synthetic latex or NR-based natural latex, and then, putting 1˜50 kg of coffee grounds powder, which has been micronized to a size of at least 1,000 μm into the mixing tank for mixing; in the mixed state, additives such as fat liquor and latex dispersant are added, and pumping treatment is performed, in the mixing tank through a suction machine, for seating on a wet web table for sheet forming treatment; in addition, a dehydration process through vacuum suction treatment is performed under a continuous sheet net, which is the last step of wetness, and a drying step is performed to make coffee recycled leather.

On the other hand, forming processing step of the coffee recycled leather manufactured by the above process is passed through between squeezing rollers and pressed into a sheet-shaped recycled coffee leather having a thickness between 0.2 mm and 1.5 mm.

A fiber yarn bonding process of processing the coffee recycled leather sheet by bonding general or recycled yarn fibers to the surface of the recycled coffee leather by buffing treatment in a conventional manner and then bonding the cotton;, a needle punching process for the bonded the coffee recycled leather sheet, which is divided several times by a needle punching machine and subjected to needle punching to produce a soft and excellent coffee recycled leather sheet with excellent physical strength.

A manufacturing coffee recycled leather sheet may include: a primary surface coating process, skin laminating process, of applying eco-friendly binding materials including solvent-type or water-soluble polyurethane using release paper, an adhesive laminating process to surface of the coffee recycled leather that has undergone the primary surface coating process adhesive laminating process, and then an adhesive process, i.e., a compression bonding process, after bonding to the surface of the recycled coffee leather sheet.

Hereinafter, a method for manufacturing a coffee recycled vegan leather sheet according to the present invention will be described in detail by way of example.

### Example 1

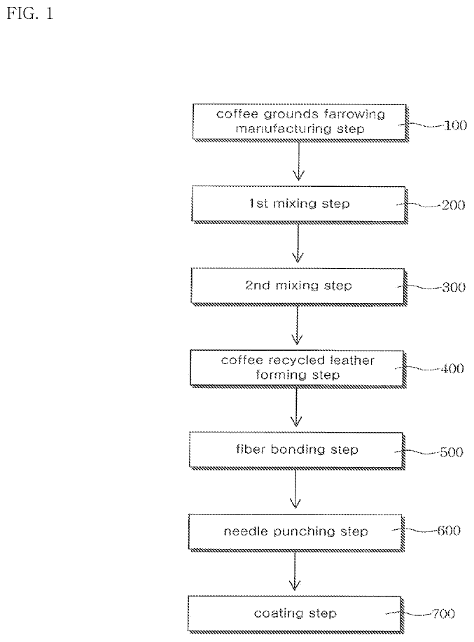

As shown in FIG. 1, the method for manufacturing a coffee recycled vegan leather sheet according to the present invention may include a coffee grounds powder manufacturing step 100; a first mixing step 200; a second mixing step 300; a coffee recycled leather forming step 400; a fiber bonding step 500; a needle punching step 600; and a coating step 700. However, it is not limited thereto.

In the coffee grounds powder manufacturing step 100, 10 to 500 kg weight of coffee grounds collected from a coffee chain store, etc. is dried with hot air supplied from a hot air blower to remove moisture, and then the dried coffee grounds are put into the grinder, and then for 2 hours or more grinding to prepare coarse coffee grounds powder or granular coffee grounds powder. At this time, the temperature condition of the hot air blower is maintained at 100˜120° C., it is preferable that the drying time is 24 hours or more.

Next, the ground coffee grounds powder is put in a vacuum container and then put into a freezer and rapidly frozen at a low temperature. At this time, during rapid cooling, the temperature should be kept below −10° C., and the frozen state may be maintained for more than 3 hours.

Thereafter, a vacuum is applied to the vacuum container at a pressure of 760 to 10⁻³ Torr to sublimate the moisture remaining in the coffee grounds powder to water vapor to dry the coffee grounds powder, after taking out the coffee grounds powder from the vacuum container, it is put into a grinder once again, and then ground for at least 2 hours to prepare a coffee grounds powder having a particle size of 1,000 μm.

At this time, the reason for freeze-drying the coffee grounds powder is to minimize the inherent coffee aroma components such as caffeine contained in the coffee grounds powder. This is because the freeze-drying method has a small increase in crystallinity compared to the hot-air drying method and is very advantageous in maintaining a microstructure such as processing or fibrous phase.

The first mixing step 200 is inputting the coffee grounds powder obtained in the above-described coffee grounds powder manufacturing step 100, shaving scrap, water, SBR-based synthetic latex or NR-based natural latex to a mixing tank for mixing.

The shaving scrap is made by pulverizing long and short fibers to a length of 10 to 100 mm, which is a raw material for recycled leather, and a weight of 300 to 800 kg of the shaving scrap is put into the mixing tank.

At this time, any one of natural fiber yarns, PU-based, PE-based, CDP, and the like general synthetic fibers or recycled yarns may be mixed and put into the mixing tank.

And 20 Ton to 25 Ton of water is put into the mixing tank. The fiber used for the shaving scrap may be leather, such as natural leather or artificial leather, or various leather wastes.

And 10˜500 kg weight of coffee grounds powder processed into a particle size of 1,000 microns (μ) in the previous step, coffee grounds powder manufacturing step 100, the shaving scrap and water.

Then, the SBR-based synthetic latex or NR-based natural latex is put into a mixing tank and mixed.

The second mixing step 300 of the present invention is a step of adding fatliquor, which is an auxiliary material and other additives such as a latex dispersant, to the mixing tank after the first mixing step 200 is performed, and then mixing them.

The fatliquor is a composition added to give flexibility to the mixture, and it is preferable to put 100 to 300 kg weight in the mixing tank.

As the fatliquor, it is preferable to select anyone selected from sulfated fatliquor, sulfited fatliquor, sulphunated fatliquor, and phosphated fatliquor.

In addition, the additive has the purpose of emulsifying and dispersing the drug, and it is preferable to put 10 to 200 kg of the weight in the mixing tank.

The mixtures that have passed through the first mixing step 200 and the second mixing step 300 are preferably introduced into the mixing tank and the mixed mixtures are forcibly sucked from the mixing tank through a conventional suction machine, and after dispersing in a filter mesh (wet table, mash form), the mixture is dehydrated through a vacuum suction device provided under the filter mesh and dried for a certain period of time to prepare coffee recycled leather.

The coffee recycled vegan leather forming step 400 of the present invention is a step of passing the coffee recycled leather manufactured through the previous processes through a squeezing roller to control a thickness of the coffee recycled leather in a sheet form.

At this time, it is preferable to press using a pressure roller to adjust the thickness of the coffee recycled leather press-molded through the press to a thickness between 0.2 mm and 1.5 mm.

In the fiber bonding step 500 of according to an aspect of the present invention, after buffing treatment, i.e., sandpapering, the surface of the coffee recycled leather press-molded in the previous step, coffee recycled leather molding step 400, in a conventional manner, and then bonding fiber any one of fiber selected from a general yarn such as polyurethane (PU), Polyethylene (PE), or Cationic Dyeable Polyester (CDP), a natural yarn or a recycled yarn.

The needle punching step 600 according to aspect(s) of the present invention is also referred to as the needle molding step, and the coffee recycled leather to which the fibers are adhered is slowly passed through a needle punching machine, and a multi-layers structured coffee recycled vegan leather is manufactured in the form of a sheet (hereinafter referred to as ‘coffee recycled leather sheet’).

In the coating step 700 according to aspect(s) of the present invention, an eco-friendly binding material including a solvent-type or water-soluble polyurethane using a release paper is applied to the surface of the coffee recycled leather that has undergone the needle punching step 600, which is the previous step, and then the a polyester film is bonded thereon, or the same as natural leather, or a conventional spray method, a padding method, a roll coating method, or a digital printing method, etc., to process the painting.

Coffee recycled leather manufactured in this way has deodorizing and antibacterial properties, as well as a soft and light 0.6˜1.8 mm thickness with coffee flavor.

On the other hand, according to aspects of the present invention, the coffee recycled vegan leather made by the manufacturing method as described above has antibacterial and deodorizing effects due to the coffee grounds composition, and the sheet itself has a subtle coffee scent.

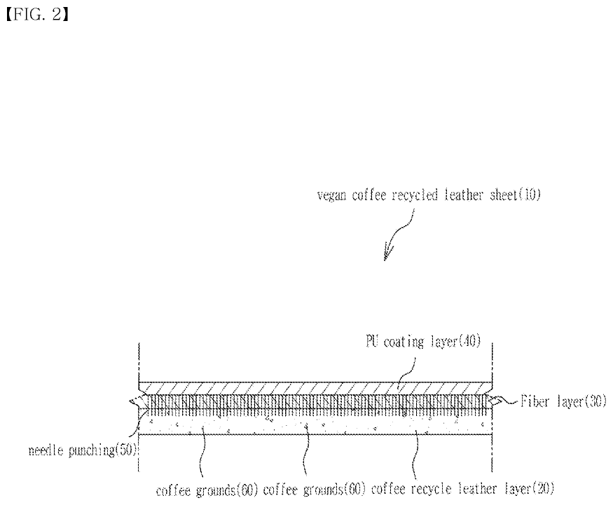

FIG. 2 is a view showing the configuration of a coffee recycled vegan leather according to an aspect of the present invention.

Referring to FIG. 2 above, the coffee recycled vegan leather sheet 10 may include the recycled coffee leather 20 containing coffee grounds 60, and a fiber layer 30 is bonded thereon by a needle punching treatment 50 according to an aspect of the present invention.

A PU coating layer 40 is bonded or attached on the fiber layer 30. At this time, the coffee recycled vegan leather sheet 10 is made by various manufacturing methods, and specifically, it is preferable to be made by the manufacturing method of FIG. 1 according to an aspect of the present invention.

As seen above, the coffee recycled vegan leather sheet 10 of the present invention may be manufactured in the same manner as in FIG. 1 or may be manufactured in various ways.

Its technical feature is not that it is manufactured by any method, but that the coffee grounds 60 are contained in the coffee recycled leather 20 itself corresponds to an essential component.

At this time, the coffee grounds 60 correspond to by-products left after making coffee as described in the term summary of the present invention, which means the residues left after extracting the coffee undiluted solution from the ground coffee, in addition, it may also refer to the epidermis and by-products of green coffee beans peeled from green coffee beans.

According to aspect of the present invention, when manufacturing the coffee recycled vegan leather sheet 10, coffee powder can be used without using the coffee grounds mentioned above.

On the other hand, in addition to the coffee recycled vegan leather sheet as shown in FIG. 2 prepared by the above method, a fiber layer is bonded on the recycled leather layer containing coffee grounds and needle punching treatment is performed on them, and then a PU layer is formed thereon. after evenly spraying the coffee grounds powder again on the PU layer, another PU layer can be formed on the PU layer according to aspects of the present invention.

In addition, coffee grounds powder can be added when producing release paper without adding coffee grounds powder when manufacturing recycled leather, that is, a fiber layer is bonded on a general recycled leather layer, a PU layer may be formed thereon by needle-punching, the coffee grounds powder may be evenly applied on it, and then another PU layer may be formed thereon according to an aspect of the present invention.

### EXPLANATION OF NUMERAL REFERENCES

10: coffee recycled vegan leather sheet
20: coffee recycle leather layer
30: fiber layer
40: PU coating layer
50: needle punching
60: coffee grounds
100: coffee grounds powder manufacturing step
200: 1st mixing step
300: 2nd mixing step
400: coffee recycled leather forming step
500: fiber bonding step
600: needle punching step
700: coating step

1. A method of preparing vegan coffee leather sheet, comprising:
a coffee grounds powder manufacturing step of drying the coffee grounds to remove moisture, and then grinding the same to produce a coffee grounds powder in a micronized form;
a first mixing step of mixing the coffee grounds powder obtained from the coffee grounds powder manufacturing step, scraps and latex, which are typically used as raw materials for recycled leather, into a mixing tank, respectively;
a second mixing step of adding a fatliquor and a dispersant for imparting flexibility to the mixture into the mixing tank that has undergone the first mixing step, and mixing them; and
drying the results of the mixture and passing through the pressing rollers for compressing and molding into coffee recycled leather sheet.

2. A vegan coffee recycled leather sheet manufacturing method of claim 1, further comprising:
a needle punching step in which the fibers are bonded to the surface of the coffee recycled leather through the coffee recycled leather molding step, and then needle punched to reinforce the physical strength.

3. The coffee grounds powder manufacturing step of claim 1, further comprising:
grinding the dried coffee grounds to produce coffee grounds powder;
drying the coffee grounds to remove moisture; and
rapidly freezing the coffee grounds powder.

4. The method for producing a vegan coffee recycled leather sheet of claim 1, wherein the coffee grounds powder has a particle size of 1,000 μm or less.

5. The method for producing a vegan coffee recycled leather sheet of claim 1, wherein the latex is selected from SBR-based synthetic latex or NR-based natural latex.

6. The method for producing a vegan coffee recycled leather sheet of claim 2, wherein the fibers are selected from general yarn fibers, natural yarn fibers, and recycled fibers.

7. A method of manufacturing a vegan coffee recycled leather sheet of claim 6, wherein the general yarn fiber is selected from any one of polyurethane (PU)-based, Polyethylene (PE)-based, and Cationic Dyeable Polyester (CDP)-based general yarn.

8. A vegan coffee recycled leather sheet, comprising:
a coffee recycled leather layer containing coffee grounds;
a fiber layer bonded on the surface of the coffee recycled leather layer,
wherein the fiber layer and the coffee recycled leather layer is needle-punched; and
a PU coating layer on the surface of the fiber layer.

9. The vegan coffee recycled leather sheet of claim 8,
wherein the surface of the PU layer is evenly sprayed with coffee grounds powder and then a PU coating layer is formed thereon.

10. A vegan coffee recycled leather sheet with a fiber layer,
wherein the vegan coffee recycled leather sheet comprising:
wherein the fiber layer is bonded on the recycled leather layer and needle-punched; a polyurethane (PU) layer is formed on top of the fiber layer, and coffee grounds powder is evenly applied thereon to form a PU coating layer.

11. The coffee grounds powder manufacturing step of claim 2, further comprising:
grinding the dried coffee grounds to produce coffee grounds powder;
drying the coffee grounds to remove moisture; and
rapidly freezing the coffee grounds powder.

12. The method for producing a vegan coffee recycled leather sheet of claim 2, wherein the coffee grounds powder has a particle size of 1,000 μm or less.

13. The method for producing a vegan coffee recycled leather sheet of claim 2, wherein the latex is selected from SBR-based synthetic latex or NR-based natural latex.
